(19) United States
(12) Patent Application Publication
(10) Pub. No.: US 2016/0221418 A1
(43) Pub. Date: Aug. 4, 2016

(54) SOLAR-POWERED FAN FOR A RECREATION VEHICLE AND SOLAR-POWERED, VENT COVER THAT FITS ON TOP OF A RECREATIONAL VEHICLE ROOF HAVING A FAN

(71) Applicant: Stoett Industries, Hicksville, OH (US)

(72) Inventors: Jack Stover, Archbold, OH (US); Dan Joseph Rheaume, Seattle, WA (US)

(21) Appl. No.: 15/095,185

(22) Filed: Apr. 11, 2016

Related U.S. Application Data
(63) Continuation-in-part of application No. 14/495,309, filed on Sep. 24, 2014.
(60) Provisional application No. 61/881,862, filed on Sep. 24, 2013.
(60) Provisional application No. 61/900,148, filed on Nov. 5, 2013.

(51) Int. Cl. B60H 1/24; B60H 1/00; B60H 1/26

(52) U.S. Cl. CPC B60H 1/245; B60H 1/262; B60H 1/00428; B60H 1/00735

(57) ABSTRACT

A solar-powered, fan-equipped vent cover is fitted on top of a recreational vehicle roof vent. The vent cover protects the recreational vehicle vent when raining, and includes a solar panel operating a fan to boost the effectiveness of the recreational vehicle roof vent in removing hot air from the recreational vehicle interior living space. The vent cover also includes a battery back-up.

### CROSS REFERENCE TO RELATED APPLICATIONS

This application is a continuation-in-part of U.S. patent application Ser. No. 14/495,309 for SOLAR-POWERED FAN FOR A RECREATION VEHICLE AND SOLAR-POWERED, FAN EQUIPPED VENT COVER THAT FITS ON TOP OF A RECREATIONAL VEHICLE ROOF VENT, filed on Sep. 24, 2014 which claims the benefit of U.S. Provisional Application No. 61/881,862, filed on Sep. 24, 2013 and U.S. Provisional Application No. 61/900,148, filed on Nov. 5, 2013. The entire disclosure of each of the above applications is incorporated herein by reference.

### FIELD

The present disclosure relates to a fan for a roof vent and more particularly relates to a solar powered fan for a recreational vehicle roof vent.

### BACKGROUND

Recreational vehicles (RVs) get extremely hot inside without proper ventilation. Although vent covers exist none of them include a solar-powered fan unit that uses the power of the sun to more effectively remove hot air from an RV's interior living space.

### SUMMARY

Concordant and congruous with the present invention, an improved solar-powered fan for RV's has surprisingly been discovered.

According to several aspects, a solar-powered recreational vehicle vent system includes a vent cover. A solar panel inset is connected to an upper wall of the vent cover. A solar panel is supported by the solar panel inset. A vent cover fan grill is connected to the vent cover. A first fan is connected to the vent cover fan grill. Electrical power to operate the first fan is directly provided by the solar panel.

According to other aspects, a solar-powered recreational vehicle vent system includes a vent cover; a solar panel inset connected to an upper wall of the vent cover. A solar panel is supported by the solar panel inset. A vent cover fan grill is connected to the vent cover. A first fan and a second fan are connected to the vent cover fan grill. Electrical power to operate the first fan and the second fan is provided by the solar panel. A rechargeable back-up battery is connected to and charged by the solar panel. The first fan and the second fan are optionally operated by electrical energy stored in the rechargeable back-up battery when solar energy is unavailable for operation of the solar panel.

In one embodiment of the invention, a solar-powered recreational vehicle vent system, comprises at least one fan disposed in a roof of a recreational vehicle; a solar panel; a vent cover disposed over the at least one fan and having the solar panel connected thereto; and a rechargeable battery back-up-extender in electrical connection with the solar panel and the at least one fan, wherein electrical power to operate the at least fan is provided by the solar panel when the solar panel is generating power or by the battery back-up-extender when the solar panel is not generating power.

In another embodiment of the invention, a solar-powered recreational vehicle vent system, comprises at least one fan disposed in a roof of a recreational vehicle; a solar panel; a vent cover disposed over the at least one fan and having the solar panel connected thereto; and a rechargeable battery back-up-extender in electrical connection with the solar panel and the at least one fan, wherein electrical power to operate the at least fan is provided by the solar panel when the solar panel is generating power or by the battery back-up-extender when the solar panel is not generating power; and a controller in communication with the solar panel, the at least one fan, and the battery back-up extender to control how power from the solar panel is selectively distributed to the at least one fan and the battery back-up extender.

In another embodiment of the invention, a solar-powered recreational vehicle vent system, comprises at least one fan disposed in a roof of a recreational vehicle; a solar panel; a vent cover disposed over the at least one fan and having the solar panel connected thereto; and a rechargeable battery back-up-extender in electrical connection with the solar panel, a battery of the recreational vehicle, and the at least one fan, wherein electrical power to operate the at least fan is provided by the solar panel when the solar panel is generating power or by the battery back-up-extender when the solar panel is not generating power; and a controller in communication with the solar panel, the at least one fan, the battery of the recreational vehicle, and the battery back-up extender to control how power from the solar panel is selectively distributed to the at least one fan, the battery of the recreational vehicle, and the battery back-up extender.

The present invention protects the interior of the RV during inclement weather, but also includes a solar-powered fan unit that will boost the effectiveness of an RV's vent in removing hot air from the RV's interior living space.

### DRAWINGS

The drawings described herein are for illustrative purposes only of selected embodiments and not all possible implementations, and are not intended to limit the scope of the present disclosure.

FIG. 1 is a top left perspective view of a vent fan housing and system of the present disclosure;

FIG. 2a is a top plan view of the vent fan housing of FIG. 1;

FIG. 2b is a rear end elevational view of the vent fan housing of FIG. 1;

FIG. 2c is a side elevational view of the vent fan housing of FIG. 1;

FIG. 3a is a top plan view of a vent cover fan grill of the vent fan housing of FIG. 1;

FIG. 3b is an end elevational view of the vent cover fan grill of FIG. 3a; and

FIG. 3c is a side elevational view of the vent cover fan grill of FIG. 3a.

FIG. 4 is an exploded perspective view of an RV vent system according to another embodiment of the invention; and

FIG. 5 is a diagram showing the interconnection of a solar panel of an RV vent system with components of the RV according to another embodiment of the invention.

Corresponding reference numerals indicate corresponding parts throughout the several views of the drawings.

### DETAILED DESCRIPTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The present invention improves upon the device disclosed in U.S. patent application Ser. No. 61/881,862 hereby incorporated herein by reference in its entirety. Elements of the invention may also improve upon the vent fan disclosed in U.S. patent application Ser. No. 13/345,545 hereby incorporated herein by reference in its entirety. The improvements of the invention includes the following:

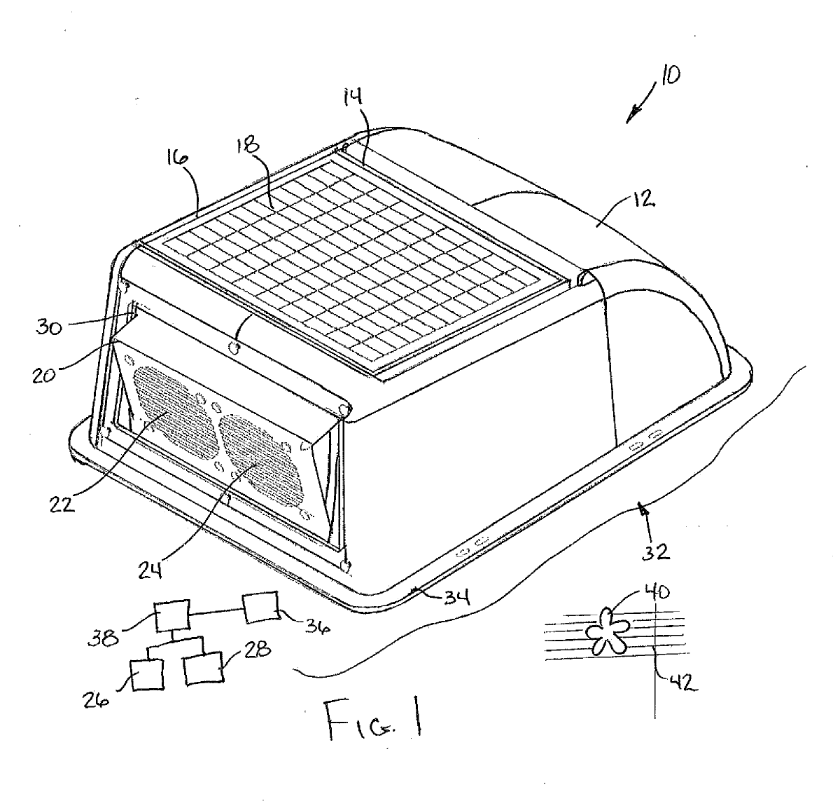

Referring in general to FIGS. 1-3, an RV vent system 10 includes a vent fan housing or vent cover 12 which can be created for example as a molding of a polymeric material. Vent cover 12 includes a solar panel inset 14 which according to several embodiments is connected to an upper wall 16 of the vent cover 12. A solar panel 18 is supported by the solar panel inset 14. A vent cover fan grill 20 which can also be made as a molding of a polymeric material is provided with vent cover 12 which provides support for a first fan 22 and a second fan 24. Electrical power to operate the first fan 22 and the second fan 24 is provided by the solar panel 18. An on/off switch 26 can be provided for manual operation and a thermostat 28 can be provided for automatic operation of the first fan 22 and/or the second fan 24.

To assemble the RV vent system 10 the first fan 22 and the second fan 24 are attached to the vent cover fan grill 20 using clips such as Christmas tree clips. The vent cover fan grill 20 is then inserted into an opening 30 of the vent cover 12 and attached to the vent cover 12 using clips such as Christmas tree clips. The solar panel 18 is then inserted into the solar panel inset 14 and the solar panel inset 14 is connected to the vent cover 12. Electrical connections are made between the solar panel 18 and the first fan 22 and the second fan 24, and to the on/off switch 26 and to the thermostat 28. The vent cover 12 is oriented on the recreational vehicle roof 32 such that the vent cover fan grill 20 is directed facing a back end or rear of the recreational vehicle. An integral flange 34 can be provided with the vent cover 12 to help seal the vent cover 12 to the recreational vehicle roof 32 using for example a gasket and/or a sealant and fasteners.

One embodiment of the invention involves incorporation of a battery back-up-extender 36 that is charged by the solar panel 18. The battery back-up extender 36 will continue running the first fan 22 and/or the second fan 24 when the sun is not present. The battery back-up extender 36 will be re-charged by the solar panel 18 when solar energy to provide recharge energy is available.

In another embodiment, the invention involves incorporating into the vent fan housing 12 the solar panel 18 that will create enough wattage power to operate an existing vent fan (not shown) that is mounted into the RV unit vent opening. This system will not have internal vent fans in the vent housing.

In another embodiment, the invention involves incorporating into the vent fan housing 12 the advanced solar panel 18 and a controller 38 that will operate other RV unit systems that are connected to internal 12 volt DC house batteries of the recreational vehicle. According to several embodiments controller 38 can be connected to the on/off switch 26, to the thermostat 28, and to the battery back-up extender 36. This vent fan solar system 10 will charge 12 volt DC house batteries which will then operate any DC system in the recreational vehicle. In another embodiment, a small 12 VDC vent fan 40 is attached to a back of an RV unit refrigerator (or other electronic device or appliance) inside the RV. The vent fan 40 will blow cool air over the refrigerator coils 42 and make the refrigerator approximately 40% more efficient and use less energy. This option will be powered by the vent fan housing 12 solar panel 18.

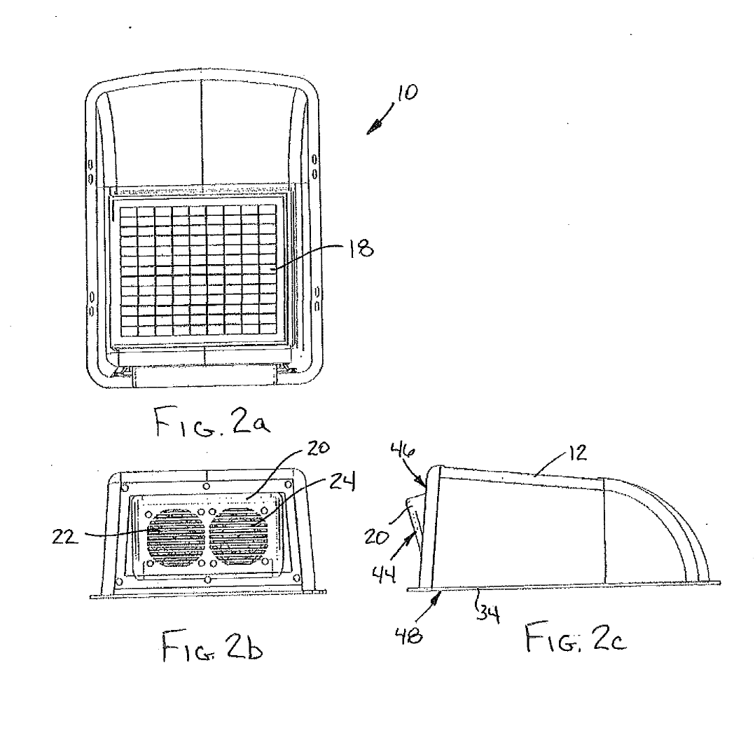

With further reference to FIG. 2c, a face 44 of the vent cover fan grill 20 is angularly oriented with respect to both a rear face 46 of the vent cover fan grill 20 and a planar face 48 defined by the flange 34. The angular orientation of the face 44 helps prevent rain and moisture from entering the vent cover fan grill 20.

With further reference to FIGS. 3c, 1, and 2c, the face 44 of the vent cover fan grill 20 is oriented at an acute angle alpha (a) defined with respect to the rear face 46. Angle alpha (α) is selected to minimize moisture entrance into the vent cover fan grill 20 while providing minimum resistance to heat removal by operation of the first fan 22 and the second fan 24.

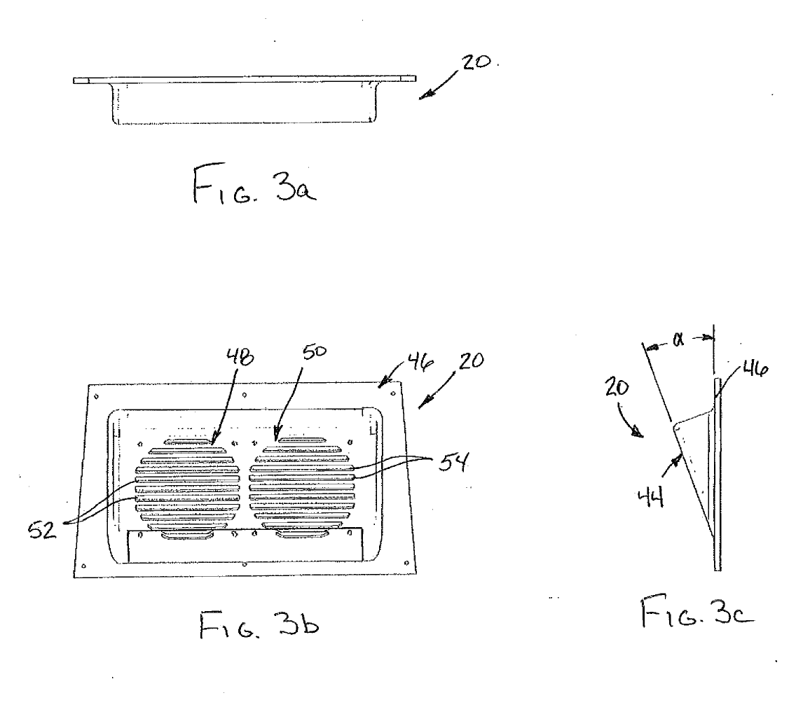

With further reference to FIGS. 3b, 1, and 2b, the vent cover fan grill 20 includes a first grill opening 48 providing multiple louvers 52 at a position of the first fan 22, and a second grill opening 50 providing multiple louvers 54 at a position of the second fan 24. The louvers 52, 54 are directed and open downwardly as viewed in FIG. 3b to help prevent incursion of rain or moisture into the vent cover fan grill 20 and thereby into the vent cover 12.

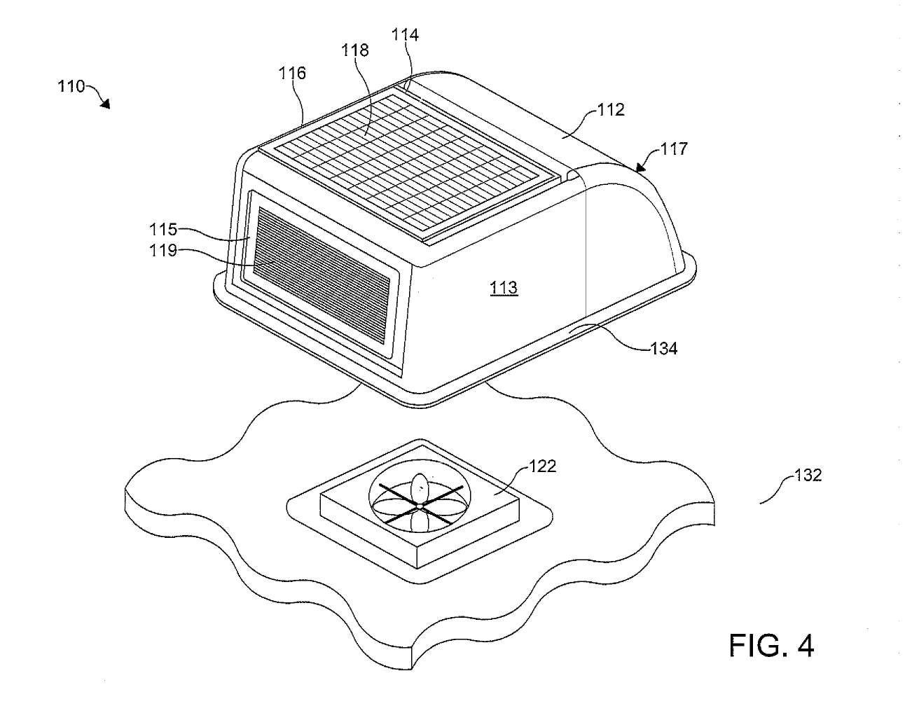

In another embodiment of the invention shown in FIG. 4, an RV vent system 110 includes a vent fan housing or vent cover 112 which can be created for example as a molding of a polymeric material. The vent cover 112 includes a solar panel inset 114 which according to several embodiments is connected to an upper wall 116 of the vent cover 112. A solar panel 118 is supported by the solar panel inset 114. Alternatively, the solar panel 118 may be attached to a top of the solar vent cover 112, such as by flanges on a frame around the solar panel 118, for example. Solar panels may also be attached to the solar vent cover 112 on one or more sidewalls thereof 113, a rear wall thereof 115, and/or a front wall thereof 117. As shown in FIG. 4, the rear 115 of the vent cover 112 includes a series of vents 119 to facilitate air flow therethrough. The vents 119 may be angled, as shown in FIG. 2c, for example, as desired. If the vents 119 are present, the space provided to facilitate a solar panel 118 is minimal. However, the vents 119 may not be present and the vent cover 112 may be hinged at the front wall thereof 117 to allow the rear wall 115 of the vent cover 112 to be elevated, such as by a hydraulic, pneumatic, or mechanical device or the like, to facilitate air flow. If multiple solar panels 118 are present, the solar panel(s) 118 may be electrically connected in parallel or in series, as desired. The solar panel(s) 118 may be rigidly formed or may be formed from a flexible photovoltaic module/material to allow for coverage of all or substantially all of the solar vent cover 112, as desired. At least one fan 122 is disposed within the recreational vehicle roof 132 and under the vent cover 112. The at least one fan 122 is structurally independent from the solar vent cover 112. Additional fans may be disposed in the recreation vehicle roof 132 abutting or adjacent to the at least one fan 122, or additional fans may be spaced apart from the at least one fan 122 but in electrical connection therewith to be powered by the system 110 described herein. Accordingly, the solar vent cover 112 may be retrofitted onto the recreational vehicle room 132 as an aftermarket component. This allows power to be provided to the at least one fan 122 without having to remove the at least one fan 122 and install a new system or different fan.

The vent cover 112 is oriented on the recreational vehicle roof 132 such that the rear wall 115 is directed facing a back end or rear of the recreational vehicle. A flange 134 can be provided with the vent cover 112 to help seal the vent cover 112 to the recreational vehicle roof 132 using for example a gasket and/or a sealant and fasteners. The flange 134 may extend along all four sides of the vent cover 112 or along one, two, or three sides, as desired.

Electrical power to operate the at least one fan 122 is provided by the solar panel(s) 118. An on/off switch 126 can be provided for manual operation and a thermostat 128 can be provided for automatic operation of the at least one fan 122.

To assemble the RV vent system 110, the solar panel 118 is inserted into the solar panel inset 114 (or fastened onto the vent cover 112) and the solar panel inset 114 is connected to the vent cover 112. Electrical connections are made between the solar panel 118 and the at least one fan 122, the on/off switch 126, the thermostat 128, and to a battery back-up-extender 138. The solar panel 118 may also be electrically connected to the primary battery of the recreational vehicle and/or to a small 12 V DC vent fan (not shown) similar to the one discussed hereinabove to a back of an RV unit refrigerator (or other electronic device or appliance) inside the recreational vehicle. The 12 V DC vent fan is configured to blow cool air over a device, such as refrigerator coils, and cool the device and facilitate a more efficient operation thereof.

The battery back-up extender 136 is adapted to continue running the at least one 122 when the sun is not present. The battery back-up extender 136 will be re-charged by the solar panel 118 when solar energy to provide recharge energy is available. The battery back-up-extender 136 may be disposed on the vent cover 112, such as on an interior thereof or on an exterior thereof to minimize a complexity of repairing or replacing the same. Alternatively, the battery back-up-extender 136 may be spaced apart from the vent cover 112 and disposed within the interior of the recreational vehicle, for example. The battery back-up-extender 136 may be in an enclosure mounted to the vent cover 112 protect the battery from the elements. If the battery back-up-extender 136 is disposed on an interior of the vent cover 112, the at least one fan 122, when in operation, will provide a flow or air over the battery back-up extender 136 to facilitate a cooling thereof and extend a useful life thereof.

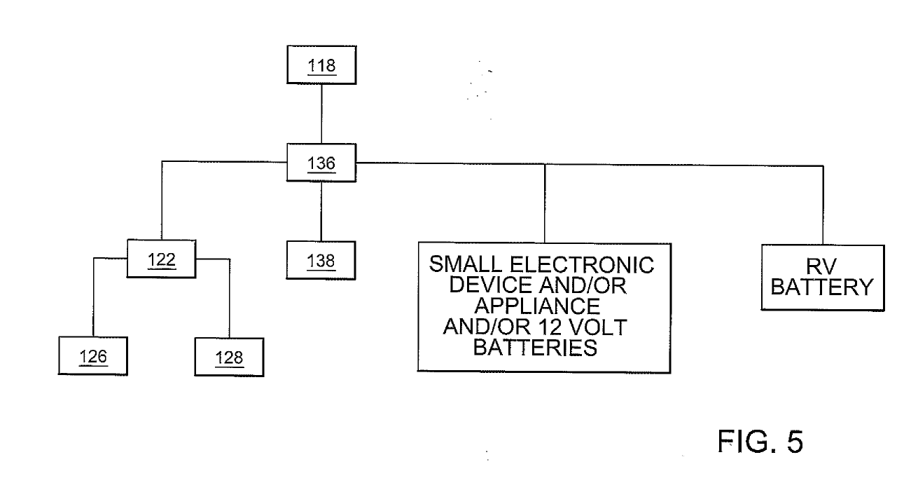

In another embodiment represented in FIG. 5, the vent cover 112 incorporates a controller 138 that will operate the at least one fan 122 and, as desired, other RV unit systems that are connected to internal 12 V DC house batteries of the recreational vehicle. According to several embodiments, the controller 138 can be connected to the on/off switch 126, the at least one fan 122, the thermostat 128, the battery back-up extender 136, and/or other components of the RV. This RV vent system 110 will charge 12 volt DC house batteries which will then operate any DC system in the recreational vehicle.

During operation of the RV vent system 110, if the solar panel(s) 118 has fully charged the battery back-up extender 136 and the at least one fan 122 is not in operation or is in operation but usage thereof does not exceed the power output of the solar panel(s) 118, the solar panel(s) may selectively trickle charge the main battery of the RV or power an alternative device within the RV, such as a small light, a fan, or an outlet. The regulation of the output of the solar panel(s) 118 may be facilitated by a controller (not shown) or other computer system in communication therewith. In this way, the solar panel(s) 118 may produce and provide power to the at least one fan 122, the battery back-up-extender 136, and/or other components of the RV so that the use of solar panel(s) 118 is maximized to generate power during power-generating hours of the day.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A solar-powered recreational vehicle vent system, comprising:
at least one fan disposed in a roof of a recreational vehicle;
a solar panel;
a vent cover disposed over the at least one fan and having the solar panel connected thereto; and
a rechargeable battery back-up-extender in electrical connection with the solar panel and the at least one fan, wherein electrical power to operate the at least fan is provided by the solar panel when the solar panel is generating power or by the battery back-up-extender when the solar panel is not generating power.

2. The solar-powered recreational vehicle vent system of claim 1, wherein the battery back-up extender is disposed on either the interior of the vent cover or the exterior of the vent cover.

3. The solar-powered recreational vehicle vent system of claim 1, further comprising an on/off switch provided for manual operation of the at least one fan.

4. The solar-powered recreational vehicle vent system of claim 1, further comprising a thermostat provided for automatic operation of at least one fan.

5. The solar-powered recreational vehicle vent system of claim 1, wherein the vent cover is a molding of a polymeric material.

6. The solar-powered recreational vehicle vent system of claim 1, wherein the fan is operated by electrical energy stored in the rechargeable back-up battery when solar energy is unavailable for operation of the solar panel.

7. The solar-powered recreational vehicle vent system of claim 1, wherein the solar panel is in electrical communication with a battery of the recreational vehicle.

8. The solar-powered recreational vehicle vent system of claim 7, wherein the battery of the recreational vehicle is trickle charged by the solar panel.

9. The solar-powered recreational vehicle vent system of claim 8, wherein the battery of the recreational vehicle is trickle charged by the solar panel only when the rechargeable battery back-up extender is fully charged and when solar energy is available for operation of the solar panel.

10. The solar-powered recreational vehicle vent system of claim 9, further comprising a controller in communication with the solar panel, the at least one fan, the battery of the recreational vehicle, and the battery back-up extender to control how power from the solar panel is selectively distributed to the at least one fan, the battery back-up extender, and the battery of the recreational vehicle.

11. The solar-powered recreational vehicle vent system of claim 1, wherein a front wall of the vent cover is hingedly fixed to the roof of the recreational vehicle to facilitate a raising of a back wall of the vent cover to facilitate a flow of air from thereunder.

12. The solar-powered recreational vehicle vent system of claim 1, wherein a back wall of the cover vent includes vents to facilitate a flow of air from under the vent cover.

13. The solar-powered recreational vehicle vent system of claim 13, the vents are angularly oriented with respect to both a rear wall of the vent cover, the angular orientation of the vents adapted to prevent rain and moisture from entering the vent cover.

14. The solar-powered recreational vehicle vent system of claim 1, further comprising a controller in communication with the solar panel, the at least one fan, and the battery back-up extender to control how power from the solar panel is selectively distributed to the at least one fan and the battery back-up extender.

15. The solar-powered recreational vehicle vent system of claim 11, further comprising an on/off switch controlling operation of the at least one fan connected to the controller.

16. The solar-powered recreational vehicle vent system of claim 15, further comprising a thermostat connected to the controller operating to control operation of the at least one fan.

17. A solar-powered recreational vehicle vent system, comprising:
at least one fan disposed in a roof of a recreational vehicle;
a solar panel;
a vent cover disposed over the at least one fan and having the solar panel connected thereto; and
a rechargeable battery back-up-extender in electrical connection with the solar panel and the at least one fan, wherein electrical power to operate the at least fan is provided by the solar panel when the solar panel is generating power or by the battery back-up-extender when the solar panel is not generating power; and
a controller in communication with the solar panel, the at least one fan, and the battery back-up extender to control how power from the solar panel is selectively distributed to the at least one fan and the battery back-up extender.

18. The solar-powered recreational vehicle vent system of claim 17, further comprising an on/off switch controlling operation of the at least one fan connected to the controller.

19. The solar-powered recreational vehicle vent system of claim 18, further comprising a thermostat connected to the controller operating to control operation of the at least one fan.

20. A solar-powered recreational vehicle vent system, comprising:
at least one fan disposed in a roof of a recreational vehicle;
a solar panel;
a vent cover disposed over the at least one fan and having the solar panel connected thereto; and
a rechargeable battery back-up-extender in electrical connection with the solar panel, a battery of the recreational vehicle, and the at least one fan, wherein electrical power to operate the at least fan is provided by the solar panel when the solar panel is generating power or by the battery back-up-extender when the solar panel is not generating power; and
a controller in communication with the solar panel, the at least one fan, the battery of the recreational vehicle, and the battery back-up extender to control how power from the solar panel is selectively distributed to the at least one fan, the battery of the recreational vehicle, and the battery back-up extender.
